(19) United States
(12) Patent Application Publication
(10) Pub. No.: US 2024/0406709 A1
(43) Pub. Date: Dec. 5, 2024

(54) Reuse Operations for eSIM Download and Transfer

(71) Applicant: Apple Inc., CUPERTINO, CA (US)

(72) Inventors: Raj S. CHAUGULE, Santa Clara, CA (US); Li LI, Saratoga, CA (US); Rohan C. MALTHANKAR, San Jose, CA (US); Sherman X. JIN, Santa Clara, CA (US); Suraj GUPTA, Santa Clara, CA (US)

(21) Appl. No.: 18/680,017

(22) Filed: May 31, 2024

Related U.S. Application Data
(60) Provisional application No. 63/505,779, filed on Jun. 2, 2023.

(51) Int. Cl. H04W 8/18; H04W 8/20; H04W 12/06

(52) U.S. Cl. CPC H04W 8/183; H04W 8/20; H04W 12/06

(57) ABSTRACT

An apparatus or method for storing records for a plurality of embedded subscriber identity module (eSIM) profiles, wherein a record for each eSIM profile comprises a state of the eSIM profile, receiving, from a first user equipment (UE), a message indicating a first eSIM profile has been deleted from the first UE, changing the state of the first eSIM profile from installed to available, receiving a message requesting the first eSIM profile be allocated to a second UE, changing the state of the first eSIM profile to a state allowing the eSIM profile to be downloaded to the second UE and downloading the first eSIM profile to the second UE.

### PRIORITY/INCORPORATION BY REFERENCE

This application claims priority to U.S. Provisional Application Ser. No. 63/505,779 entitled “Reuse Operations for eSIM Download and Transfer,” filed on Jun. 2, 2023, the entirety of which is incorporated herein by reference.

### BACKGROUND

Existing implementations of User Equipment (UE) embedded subscriber identity module (eSIM) operations have several areas in need of improvement. The creation of new eSIM profiles represents an ongoing cost to mobile network operators (MNOs). With billions of eSIM devices in use worldwide and many more eSIM devices to be deployed in the future, MNOs would like to reduce the cost associated with creating new eSIM profiles. There is a need to develop a means of reusing eSIM profiles on a different device.

### SUMMARY

Some example embodiments are related to a method for storing records for a plurality of embedded subscriber identity module (eSIM) profiles, wherein a record for each eSIM profile comprises a state of the eSIM profile, receiving, from a first user equipment (UE), a message indicating a first eSIM profile has been deleted from the first UE, changing the state of the first eSIM profile from installed to available, receiving a message requesting the first eSIM profile be allocated to a second UE, changing the state of the first eSIM profile to a state allowing the eSIM profile to be downloaded to the second UE and downloading the first eSIM profile to the second UE.

Other example embodiments are related to a method for sending, to a source user equipment (UE), a delete plan request to delete an embedded subscriber identity module (eSIM) profile, sending, to an entitlement server, a request for the eSIM profile, receiving, from the entitlement server, a response comprising information to retrieve the eSIM profile, fetching the eSIM profile from a subscription manager-data preparation+ (SM-DP+), installing the eSIM profile and sending a confirmation to the SM-DP+ that the eSIM profile was installed.

Still further example embodiments are related to a method for receiving, from a target UE, a delete plan request to delete an embedded subscriber identity module (eSIM) profile, deleting the eSIM profile and sending an indication that the eSIM profile has been deleted from the source UE.

Additional example embodiments are related to a method for receiving, from a source user equipment (UE), a push notification registration for push notifications related to a transfer of an embedded subscriber identity module (eSIM) profile installed on the source UE, receiving, from a target UE, a request to install the eSIM on the target UE, sending, to the source UE, a push notification indicating the source UE is to delete the eSIM profile, receiving, from the source UE, an indication that the eSIM profile has been deleted, sending, to a subscription manager-data preparation+ (SM-DP+), a request for the eSIM profile to be transferred to the target UE, receiving, from the SM-DP+, a response indicating the eSIM profile is to be transferred to the target UE, the response comprising a universal resource locator (URL) for the SM-DP+ and sending, to the target UE, a response to the request to install the eSIM on the target UE, the response comprising the URL for the SM-DP+.

More example embodiments are related to a method for scanning a quick response (QR) code displayed by a source user equipment (UE), determining QR code information from the scanned QR code, wherein the QR code information is related to a transfer of an embedded subscriber identity module (eSIM) profile from the source UE to a target UE, sending, to a carrier server, a request for the eSIM profile, receiving, from the carrier server, a response comprising information to retrieve the eSIM profile, wherein the information comprises a universal resource locator (URL) for a subscription manager-data preparation+ (SM-DP+), fetching the eSIM profile from the SM-DP+, installing the eSIM profile and sending a confirmation to the SM-DP+ that the eSIM profile was installed.

Further example embodiments are related to a method for sending, to a carrier server, a push notification registration for push notifications related to a transfer of an embedded subscriber identity module (eSIM) profile installed on a source user equipment (UE), generating a quick response (QR) code comprising QR code information to be displayed by the source UE, wherein the QR code information is related to the transfer of the eSIM profile from the source UE to a target UE, receiving, from the carrier server, a push notification indicating the source UE is to delete the eSIM profile and sending, to the carrier server, an indication that the eSIM profile has been deleted.

Still other example embodiments are related to a method for storing records for a plurality of embedded subscriber identity module (eSIM) profiles, wherein a record for each eSIM profile comprises a state of the eSIM profile, receiving, from a first user equipment (UE), a request for a first eSIM profile, sending, to the first UE, the first eSIM profile, receiving, from a second UE, a first indication that a second eSIM profile has been deleted from the second UE, wherein the first UE and the second UE are associated with a same account, updating, in response to the first indication, a state of the second eSIM profile to available, receiving, from the first UE, a second indication that the first eSIM profile has been installed on the first UE and updating, in response to the second indication, a state of the first eSIM profile to installed.

Still additional example embodiments are related to a method for receiving, from an entitlement server, a setup profile request for an embedded subscriber identity module (eSIM) profile for a user equipment (UE), configuring the eSIM profile for the UE and sending a push notification to the UE, wherein the push notification comprises information for the UE to fetch the eSIM profile.

Still more example embodiments are related to a method for receiving, from a target user equipment (UE), a request for a list of devices associated with a phone number, sending, to the target UE, a response comprising the list of devices associated with the phone number and sending, to a source UE, a request to delete an embedded subscriber identity module (eSIM) profile associated with the phone number.

Other example embodiments are related to a method for scanning a quick response (QR) code generated by a mobile network operator, determining QR code information from the scanned QR code, wherein the QR code information is related to a first embedded subscriber identity module (eSIM) profile and comprises a universal resource locator (URL) for a subscription manager-data preparation+ (SM-DP+), fetching the first eSIM profile from the SM-DP+, sending, to an other equipment manufacturer (OEM) cloud server, a phone number list request, receiving, from the OEM cloud server, a phone number list response comprising a list of devices are associated with a phone number of the first eSIM profile, sending, to a source user equipment (UE) that is one of the list of devices associated with the phone number, a delete plan request to delete a second eSIM profile associated with the phone number, installing the first eSIM profile and sending a confirmation to the SM-DP+ that the first eSIM profile was installed.

Further example embodiments are related to a method for receiving, from a target user equipment (UE) comprising a first embedded subscriber identity module (eSIM) profile associated with a phone number, a delete plan request to delete a second eSIM profile associated with the phone number, deleting the second eSIM profile and sending a confirmation to a subscription manager-data preparation+ (SM-DP+) that the second eSIM profile was deleted.

Additional example embodiments are related to a method for sending, to a source user equipment (UE), a delete plan request to delete an embedded subscriber identity module (eSIM) profile, receiving, from the source UE, a delete notification indicating the eSIM profile has been deleted from the source UE and sending the delete notification to a subscription manager-data preparation+ (SM-DP+).

Other example embodiments are related to an apparatus having a processor and memory coupled to the processor, the processor configured to prepare a delete plan request, to be sent to a source user equipment (UE), to request deletion of an embedded subscriber identity module (eSIM) profile on the source UE, prepare an entitlement server request for the eSIM profile, receive, in response to transmission of the entitlement server request, a response comprising information to retrieve the eSIM profile, obtain the eSIM profile from a subscription manager-data preparation+ (SM-DP+), install the eSIM profile and prepare a confirmation to be sent to the SM-DP+ that indicates that the eSIM profile was installed.

Further example embodiments are related to an apparatus having a processor and memory coupled to the processor, the processor configured to receive, from a target user equipment (UE), a delete plan request to delete an embedded subscriber identity module (eSIM) profile from a source UE, delete the eSIM profile and prepare an indication that the eSIM profile has been deleted from the source UE.

### BRIEF DESCRIPTION OF THE DRAWINGS

FIG. 1 shows an example network arrangement according to various example embodiments.

FIG. 2 shows an example UE according to various example embodiments.

FIG. 3 shows a first call flow according to various example embodiments.

FIG. 4 shows a second call flow according to various example embodiments.

FIG. 5 shows a third call flow according to various example embodiments.

FIG. 6 shows a fourth call flow according to various example embodiments.

FIG. 7 shows a fifth call flow according to various example embodiments.

### DETAILED DESCRIPTION

The example embodiments may be further understood with reference to the following description and the related appended drawings, wherein like elements are provided with the same reference numerals. The example embodiments relate to improved operations for eSIM download and transfer.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (6G networks), or any other type of network that uses eSIMs.

It is expected that there will be 2.4 billion eSIM connected devices (i.e., UEs) by the end of 2025. Each of these UEs has an associated eSIM profile used to receive cellular service from an MNO. When a user purchases a new UE, the MNO typically incurs a cost associated with generating a new eSIM profile.

An eSIM profile may have a variety of states. An eSIM profile in an available state may be used by an MNO. Once the eSIM profile is installed on a UE, the eSIM profile enters an installed state. An eSIM profile in the installed state cannot be used again, even for the same phone number. Therefore, a user with a new UE (e.g., upgrading their device) receives a new eSIM profile from their MNO when transferring their phone number to the new UE.

Despite MNOs paying for these new eSIM profiles, the old eSIM profile (from the old UE) remains in a linked state with the old UE embedded universal integrated circuit card (eUICC) Identifier (EID). This represents a recurring cost to MNOs. The example embodiments provide manners of reducing this cost to MNOs by allowing eSIM profiles to be reused. For example, some example embodiments relate to deleting an eSIM profile from an old UE and transitioning the eSIM profile back to the available state. This allows for the same eSIM profile to be used with a new UE. The example embodiments relate to improved UE and network handling of eSIM profiles between UEs. The example embodiments will be described in greater detail below.

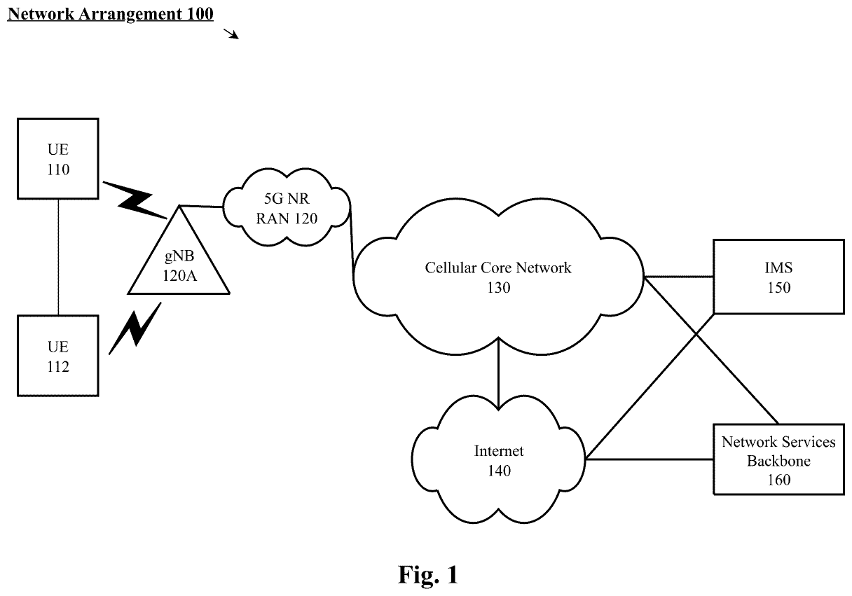

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of one UE 110 is merely provided for illustrative purposes. The example network arrangement 100 also includes a UE 112. The UE 112 may be functionally equivalent to the UE 110. In the example embodiments, the UE 110 may be the device that currently has the eSIM profile in the installed state (e.g., the old device) and THE UE 112 may be the target device (e.g., the new device) of an eSIM transfer operation.

The UEs 110 and 112 may be configured to communicate with one or more networks. In the example of the network configuration 100, the network with which the UEs 110 and 112 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. Regarding the example embodiments, the UEs 110 and 112 may establish a connection with the 5G NR RAN 120. Therefore, the UE 110 may have a 5G NR chipset to communicate with the NR RAN 120. The UEs 110 and 112 may communicate with the one or more networks when an eSIM profile is installed on the UE. The example embodiments will describe this installation and the transfer of the eSIM profile between the UEs 110 and 112 in more detail.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UEs 110 and 112 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UEs 110 and 112 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UEs 110 and 112 using the IP protocol. The IMS 150 may communicate with the cellular core network 130 and the Internet 140 to provide the multimedia services to the UEs 110 and 112. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

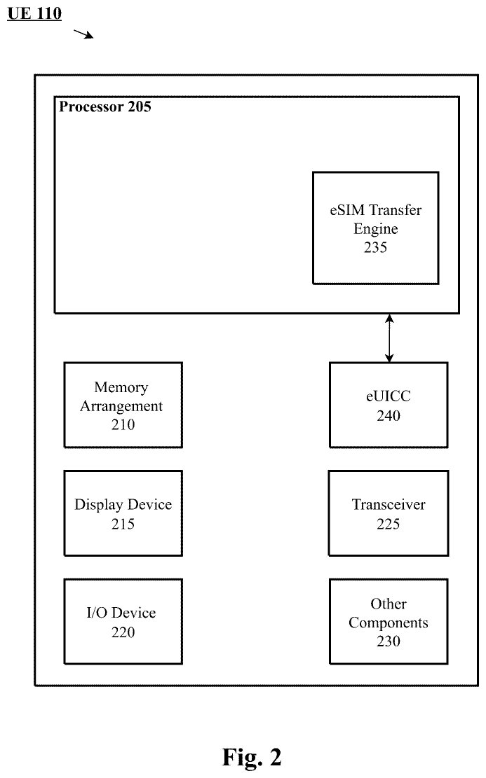

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. An eUICC 240 may be a hardware component embedded into the UE 110 configured to store a number of carrier profiles.

The processor 205 may be configured to execute a plurality of engines for the UE 110. For example, the engines may include an eSIM transfer engine 235 for performing operations related to improved eSIM transfers between the UE 110 and the UE 112. The eSIM transfer engine may also execute a local profile assistant (LPA) function that allows the UE 110 to download encrypted profiles to the eUICC 240 of the UE 110.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

As described above, in the example embodiments, the UE 110 may be the old device, e.g., the device that currently has the eSIM profile installed. The UE 112 will be considered to be the new device, e.g., the target device on which the eSIM profile is to be installed. The description above for the UE 110 is also applicable to the UE 112. For example, eSIM transfer engine 235 may be used by the old device (e.g., the UE 110) to perform the operations described below during the example transfer operations. Similarly, the eSIM transfer engine 235 may be used by the new device (e.g., the UE 112) to perform the operations described below during the example transfer operations.

The example embodiments relate to improved UE and network handling of eSIM profile transfer between UEs. There may be multiple example use cases for transferring the eSIM profiles between the UEs. The following will describe these example use cases in greater detail.

In a first aspect of the example embodiments, eSIM transfer using UE proximity is disclosed. As stated above, throughout the remainder of the disclosure, the UE 110 may be a source UE (e.g., old UE), and the UE 112 may be a target UE (e.g., new UE). The UE 110 may have a phone number (and eSIM) associated it with. As described above, the UEs 110 and 112 may include an LPA (e.g., an application resident on the UE or the eUICC) that may be used to manage eSIM profiles of the UE 110 and the UE 112. Operations related to managing eSIM profiles may include downloading new eSIM profiles, activating eSIM profiles, deactivating eSIM profiles, deleting eSIM profiles, etc.

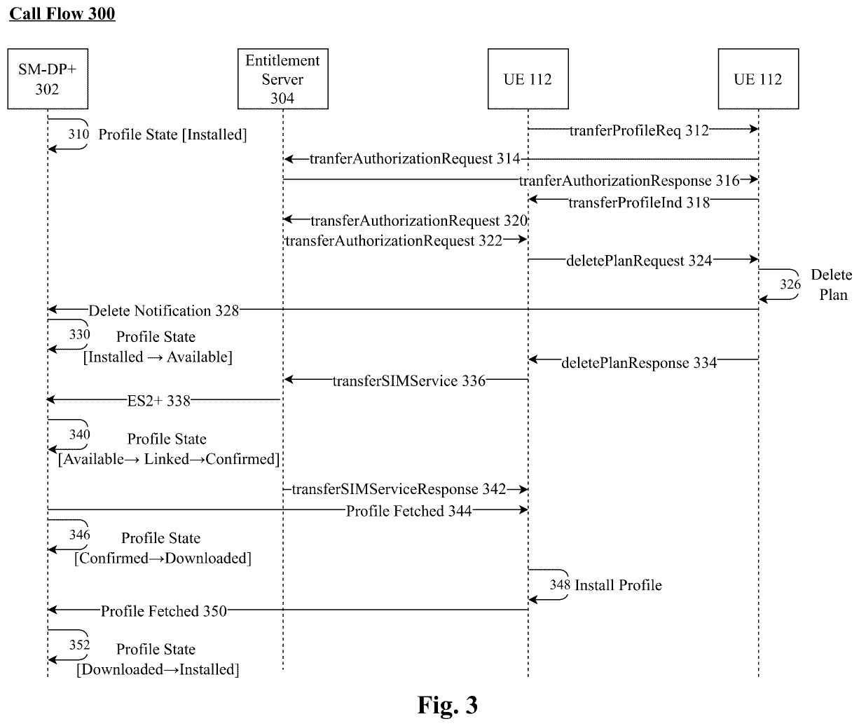

FIG. 3 shows a first call flow 300, according to various example embodiments. Description of the call flow 300 may describe the first aspect. FIG. 3 shows an SM-DP+ 302, which is a network element (typically a server) that prepares, stores, and protects carrier profiles (including operator credentials). The SM-DP+ 302 may also download and install profiles to a UE eUICC (e.g., the eUICC 240). Other entities or networks may refer to the SM-DP+ by other names. FIG. 3 also shows an entitlement server 304, which enables over-the-air configuration of UE eSIMs. FIG. 3 also shows the UE 112 (the target device) and the UE 110 (the source device). In this example, it may be considered that the UE 110 and the UE 112 are located physically nearby one another throughout the operations of the call flow 300.

In 310, the SM-DP+ 302 has the profile state “Installed” associated with the eSIM profile installed on the UE 110. This is the typical state of the eSIM profile on a UE being used by a user with a cellular contract with an MNO during the lifespan of the UE.

In 312, the UE 112 transmits a transfer profile request to the UE 110. This may be initiated by a user through an interaction on the UE 112. As stated above, in this scenario, the UE 110 and the UE 112 are in close proximity to one another. Thus, the UE 112 may send the transfer profile request using any short range protocol or communication method such as Bluetooth, short range WiFi, Near field communications (NFC), infrared, etc.

In 314, the UE 110 transmits a transfer authorization request to the entitlement server 304. The transfer authorization request informs the entitlement server that the eSIM profile on the UE 110 is requested to be transferred. The transfer authorization request may include any information that the entitlement server 304 may use to authorize the transfer of the eSIM profile, e.g., an identification (ID) of the eSIM profile, an ID of the UE 110, an ID of the UE 112, an ID of the subscriber, etc.

In 316, the entitlement server 304 transmits a transfer authorization response. In the call flow 300, it is considered that the transfer authorization response is affirmative and the call flow 300 continues. However, if the transfer authorization response is negative, the call flow 300 would terminate.

In 318, the UE 110 transmits a transfer profile indication to the UE 112. The indication 318 informs the UE 112 to proceed with the call flow 300, and to transmit the transfer authorization request 320 to the entitlement server 304. At this point, the UE 112 does not have the eSIM profile so it is typically unable to access a cellular network at this time. However, the UE 112 may have WiFi access and is able to contact the entitlement server 304 using the WiFi access. Thus, in 320, the UE 112 transmits the transfer authorization request to the entitlement server 304.

In 322, the entitlement server responds to the UE 112 with a transfer authorization response. Again, the transfer authorization request 320 may include any information that the entitlement server 304 may use to authorize the transfer of the eSIM profile, examples of which were described above. Also, it may again be considered that the transfer authorization response is affirmative because a negative transfer authorization response would terminate the call flow 300. The operations 324-322 may be described as pre-flight operations, e.g., operations that are used to prepare the devices to perform the transfer but may not be part of the transfer operations. In this example, these pre-flight operations are related to authorizations. As will be described in greater detail below, there may be other types of pre-flight operations related to authorizations including obtaining authorization tokens. Any of these pre-flight operations may be used with any of the transfer call flow operations, e.g., in this example, instead of using the operations 324-322, the authorization tokens that are described below may be used.

In 324, the UE 112 transmits a delete plan request to the UE 110. The delete plan request 324 informs the UE 110 that it should delete the eSIM profile. In 326, the UE 110 deletes the eSIM profile. This deletion 326 wipes the eSIM profile from the device (e.g., the eUICC 240), such that following 326, the UE 110 no longer has access to the eSIM profile. It should be noted however, that at the conclusion of 326, the SM-DP+ 302 does not yet know the profile has been deleted from the UE 110.

In 328, the UE 110 transmits a delete notification to the SM-DP+ 302, informing the SM-DP+ 302 that the eSIM profile has been deleted from the UE 110. As described above, when the UE 110 deletes the eSIM profile, the UE 110 may no longer have access to cellular service such that UE 110 may have to contact the SM-DP+ 302 using an alternate connection, e.g., WiFi. In some example embodiments, it is possible that that the UE 110 sends the delete notification 328 using the cellular connection prior to the actual deletion 326.

In 330, the SM-DP+ 302 updates the eSIM profile state from installed to available. This is consistent with the UE 110 deleting the profile in the operation 326. Since the eSIM profile is now in the available state, the eSIM profile may be used by a new UE (e.g., the UE 112). Thus, at the conclusion of the operation 330, the eSIM profile is now available to be reused.

In 334, the UE 110 transmits a delete plan response to the UE 112. The response 334 informs the UE 112 that the UE 110 has successfully deleted the eSIM profile and informed the SM-DP+ 302 (in the operation 328) of the eSIM profile deletion.

In 336, the UE 112 transmits a transfer SIM service message to the entitlement server 304. The message 336 informs the entitlement server 304 that the UE 112 should receive the SIM service of the old UE (e.g., the UE 110). The message 336 includes the source device (the UE 110) Integrated Circuit Card Identification (ICCID) profile, including the SRC ICCID.

In 338, the entitlement server 304 transmits an ES2+ message to the SM-DP+ 302, indicating that the UE 112 is ready to receive the eSIM profile. The ES2+ is an interface allowing the UE 112 to communicate with the SM-DP+ 302.

In 340, the SM-DP+ updates the eSIM profile state from available, to linked and then to confirmed. The linked state indicates that the eSIM profile is reserved for downloading and is linked to an embedded identity document (EID), e.g., a serial number attached to a device that uses an eSIM. In this example, the EID is the EID of the UE 112. The confirmed state indicates that the eSIM profile is reserved for downloading with a Matching ID (e.g., a unique ID for each connection) and a confirmation code (e.g., a carrier provided code), if required.

In 342, the entitlement server 304 transmits a transfer SIM response message 342 to the UE 112. The message 342 includes an ICCID. In 344, the SM-DP+ 302 transmits the eSIM profile to the UE 112. In 346, the SM-DP+ 302 updates the Profile state from Confirmed to Downloaded.

In 348, the UE 112 installs the eSIM profile, including the EID from the UE 110 (maintaining the same EID). In 350, the UE 112 transmits a profile fetched message response to the SM-DP+ 302, indicating that the profile has been installed.

In 352, the SM-DP+ 302 updates the profile state from downloaded to installed. The steps of the call flow 300 can be repeated again at a future time when a user upgrades or changes devices from the UE 112.

In a second aspect of the example embodiments, eSIM transfer via a quick response (QR) code and an original equipment manufacturer (OEM) cloud service is disclosed. QR codes can be quickly generated by a source UE to supply a target UE with necessary profile information to begin the eSIM transfer.

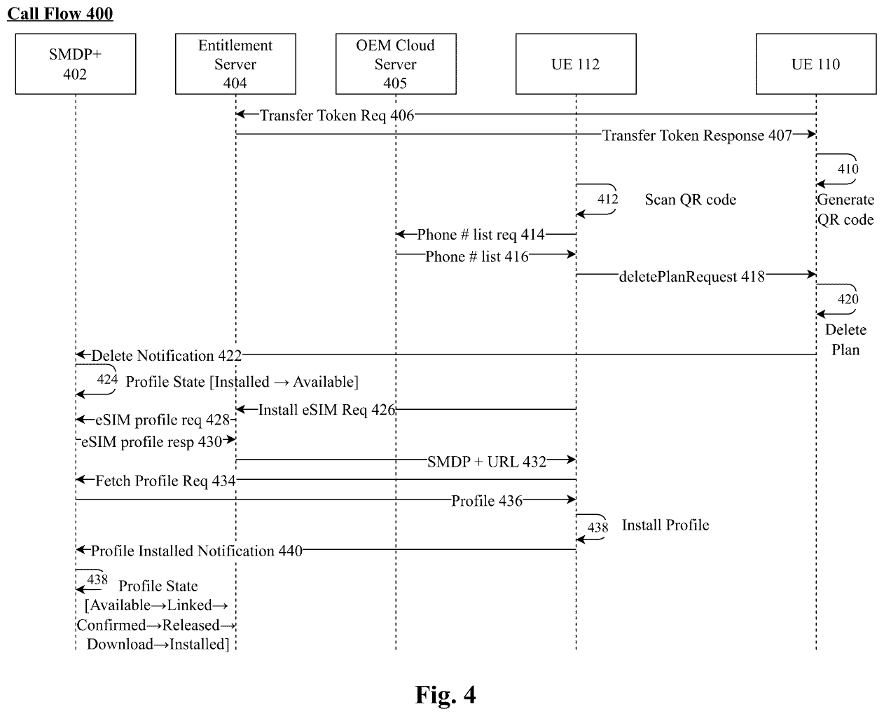

FIG. 4 shows a second call flow 400, according to various example embodiments. The call flow 400 may describe the second aspect. The entitlement server 404 and SM-DP+ 402 are substantially similar to the entitlement sever 304 and SM-DP+ 302 described with reference to FIG. 3. FIG. 4 features an OEM cloud server 405, which may be a server with relevant account information tied to a specific user account. For example, the OEM cloud server may know which UEs are associated with a given OEM user account or phone number (smartphone, tablet, smart watch, etc.). Again, in this example, it may be considered that the UE 110 and the UE 112 are in proximity to one another.

In 406, the UE 110 transmits a transfer token request to the entitlement server 404. In 407, the entitlement server 404 responds to the UE 110 with the transfer token. In some example embodiments, the transfer token request 406 may be initiated by the user of the UE 110. For example, the user may have obtained a new device (e.g., UE 112) and would like to initiate the eSIM profile transfer operation. As part of initiating the transfer, the user may request the UE 110 obtain the transfer token to perform the transfer. In other example embodiments, the obtaining of the transfer token may be performed transparently to the user, e.g., when the user obtains the new device, all devices associated with a user's account may automatically request transfer tokens so the user may select any of the devices for the transfer. The transfer token may be considered to be an authorization token to allow the UE 110 to perform operations related to transferring the eSIM profile, e.g., an example of the pre-flight operations described above. The transfer token may be valid for a predetermined length of time, e.g., 1 hour, 12 hours, 24 hours, etc.

In this example, the transfer token is obtained from the entitlement server 404. However, there is no requirement that the transfer token be obtained from the entitlement server 404. For example, the transfer token may be obtained from any carrier related device or function.

In 410, the source UE (e.g., UE 110) generates a QR code. The QR code may include one or more of an ICCID, mobile country code (MCC), mobile network code (MNC), group 1 identifier (GID1), group 2 identifier (GID2), international mobile subscriber identity (IMSI), the transfer token (received in the operation 407), an indication of Is Plan Active (i.e., whether the user has a cellular plan with the MNO), International Mobile Equipment Identity (IMEI), embedded identity document (EID), Serial Number, Label, Phone Number, UE software version, Product Class (e.g., iPhone, iPad), etc.

In 412, the target UE (e.g., UE 112) scans the QR code via its camera. The scanning operation 412 also includes the UE 112 decoding the information included in the QR code.

In 414, the UE 112 transmits a phone number list request to the OEM cloud server 405 (e.g., iCloud). The purpose of the request 414 is to learn which UEs are associated with a given phone number. For example, a user may have a smartphone, smartwatch, tablet, and laptop associated with their phone number such that the user may answer a phone call on any of the devices associated with the phone number. This information ensures that only the old UE 110 (e.g., the one that displayed the QR code in 410) loses access to the phone number. For example, a user that owns a smartwatch and smartphone will likely wish to maintain access to their phone number on the smartwatch when upgrading their smartphone.

In 416, the OEM cloud server 405 responds to the UE 112 with the list of devices that use the phone number. The UE 112 can now select the correct device (e.g., UE 110) that is to lose access to the phone number and continue the call flow 400 with that device (e.g., UE 110).

In 418, the UE 112 transmits a delete plan request to the UE 110. This request informs the UE 110 to delete its eSIM profile (and associated phone number). In 420, the UE 110 deletes the eSIM profile and associated phone number. The UE 110 can no longer make or receive calls with the eSIM profile or phone number.

In 422, the UE 110 transmits a delete notification to the SM-DP+ 402 indicating that the delete operation 420 has been completed. With this information, the SM-DP+ 402 can now update the eSIM profile state knowing that the eSIM profile is no longer on the UE 110. Thus, in 424, the SM-DP+ 402 updates the profile state from installed to available.

In 426, the UE 112 transmits an install eSIM request to the entitlement server 404. In 428, the entitlement server 404 transmits an eSIM profile request 428 to the SM-DP+ 402.

In 430, the SM-DP+ 402 responds to the entitlement server 404 with information related to the eSIM profile (i.e., the profile originally installed on the UE 110) including an SM-DP+ URL. As described above, because the eSIM profile that was originally on the UE 110 has now been placed into the available state, the SM-DP+ 402 can now select that eSIM profile for reuse.

In 432, the entitlement server 404 transmits the SM-DP+ URL to the UE 112. In 434, the UE 112 transmits a fetch profile request to the SM-DP+ 402 (via its newly acquired SM-DP+ URL from 432). In 436, the SM-DP+ 402 transmits the eSIM profile to the UE 112.

In 438, the UE 112 installs the eSIM profile. In 440, the UE 112 transmits a profile installed notification to the SM-DP+ 402 informing the SM-DP+ 402 that the eSIM profile has been installed. In 442, the SM-DP+ 402 updates the eSIM profile state to installed in response to SM-DP+ 402 receiving the profile installed notification.

The eSIM profile state may be updated multiple times during the call flow 400. For example, as described above, the eSIM profile state is updated from installed to available in 424 in response to the UE 110 deleting the profile and indicating the deletion to the SM-DP+ 402. The eSIM profile state may be updated from available to linked and then to confirmed during the operations related to 436 and 438. Similarly, during the same operations the eSIM profile may be updated from confirmed to released. The released state indicates that the eSIM profile is ready for download and installing after network configuration by the operator (e.g., Home Location Register (HLR) registration). Another update to the eSIM profile state may be from released to downloaded when the eSIM profile is fetched by the UE 112, e.g., after 436. Thus, when the SM-DP+ 402 receives the profile installed notification in 440, the eSIM profile state is updated to installed.

At the conclusion of the call flow 400, the UE 112 is now operating with the eSIM profile originally installed on the UE 110, along with the associated phone number. No new eSIM profile was generated for the UE 112.

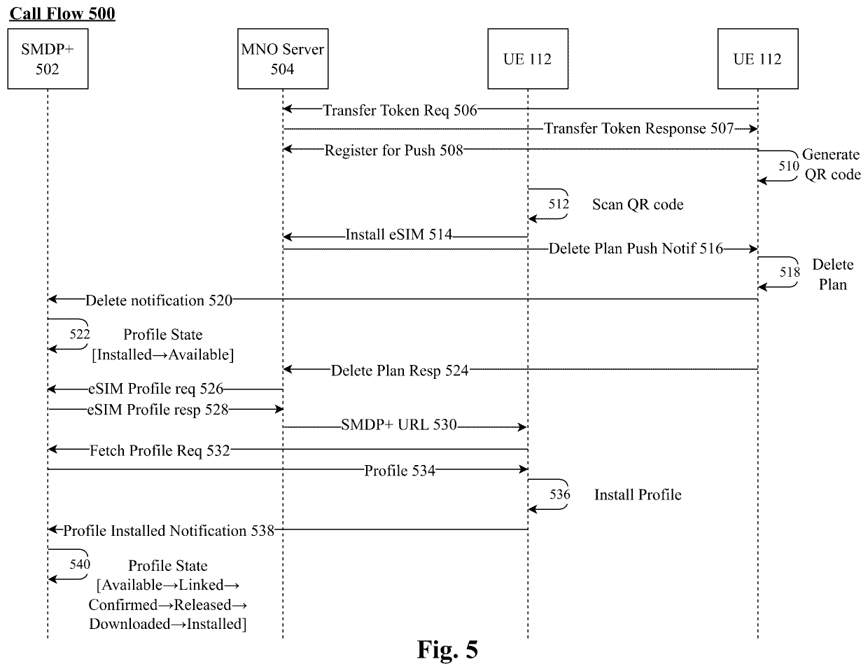

In a third aspect of the example embodiments, operations related to remote eSIM deletion are disclosed herein. FIG. 5 shows a third call flow 500, according to various example embodiments. The call flow 500 may describe the third aspect.

The call flow 500 features SM-DP+ 502, which is substantially similar to the SM-DP+ 302 described in FIG. 3. FIG. 5 also features an MNO server 504. The MNO server 504 may be a server operated by the mobile network operator with which the user has subscribed to cellular service.

The operations 506 and 507 are substantially similar to the operations 406 and 407 described above with reference to FIG. 4. A difference between the operations 506 and 507 and the operations 406 and 407 is that the UE 110 obtains the transfer token from the MNO server 504 instead of the entitlement server. However, as described above, the operations are only examples, and the UE 110 may also have obtained the transfer token from an MNO server in 406 and 407.

In 508, the UE 110 registers for push notifications from the MNO server 504. As will be described in greater detail below, the MNO server 504 may push delete notifications for an eSIM profile to the UE 110. For the UE 110 to receive these push notifications, the UE 110 registers for the push notifications in 508.

The operations 510 and 512 are substantially similar to the operations 410 and 412 described with reference to FIG. 4. Again, in this example, it is considered that the UE 110 and the UE 112 are in close proximity to one another, e.g., the UE 112 can scan the QR code on the UE 110. Examples of the types of information that may be included in the QR code were described above.

Following the UE 112 scanning the QR code in 512, in 514, the UE 112 transmits an install eSIM message to the MNO server 504. In the previous examples, the UE 112 sent a delete plan message to the UE 110 to delete the eSIM profile. However, in this example scenario, the delete plan message is sent remotely from the UE 110. Specifically, in 516, the MNO server 504 transmits a delete plan push notification to the UE 110. The delete plan push notification 516 informs the UE 110 it should delete the eSIM profile. As described above, the UE 110 previously signed up to receive push notifications from the MNO server 504.

In 518, the UE 110 deletes the eSIM profile. In 520, the UE 110 transmits a delete notification to the SM-DP+ 502. This notification 520 informs the SM-DP+ 502 that the eSIM profile has been deleted so that the SM-DP+ 502 may proceed with updating the eSIM profile status. In 522, the SM-DP+ 502 updates the eSIM profile state from installed to available, consistent with its knowledge of the UE 110 deleting the profile from the notification 520.

In 524, the UE 110 transmits a delete plan response message to the MNO server 504. The MNO server 504 now knows that the profile has been deleted from UE 110 (and that the profile is now available for UE 112).

In 526, the MNO server 504 transmits an eSIM profile request to the SM-DP+ 502. In 528, the SM-DP+ 502 responds to the MNO server 504 with information related to the eSIM profile (i.e., the profile originally installed on the UE 110) including an SM-DP+ URL. As described above, because the eSIM profile that was originally on the UE 110 has now been placed into the available state, the SM-DP+ 502 can now select that eSIM profile for reuse.

In 530, the MNO server 504 transmits the SM-DP+ URL to the UE 112. In 532, the UE 112 transmits a fetch profile request to the SM-DP+ 502 (via its newly acquired SM-DP+ URL from 530). In 534, the SM-DP+ 502 transmits the eSIM profile to the UE 112.

In 536, the UE 112 installs the eSIM profile. In 538, the UE 112 transmits a profile installed notification to the SM-DP+ 502 informing the SM-DP+ 502 that the eSIM profile has been installed. In 540, the SM-DP+ 502 updates the eSIM profile state to installed in response to SM-DP+ 502 receiving the profile installed notification. Similar to the above example, the eSIM profile state may be updated multiple times during the call flow 500, e.g., as shown in 540 from available to linked to confirmed to releases to downloaded and finally to installed. Again, all these updates do not occur at 540 but may occur at various times during the call flow 500.

In a fourth aspect of the example embodiments, signal management discovery service (SMDS) out of band operations are disclosed herein. OEM cloud services may contain information of all cellular plans available on any device on the same OEM cloud account. The OEM cloud service may match a phone number to send a delete plan request to an old UE. With the eSIM profile deleted, the profile will be available for later use by the MNO.

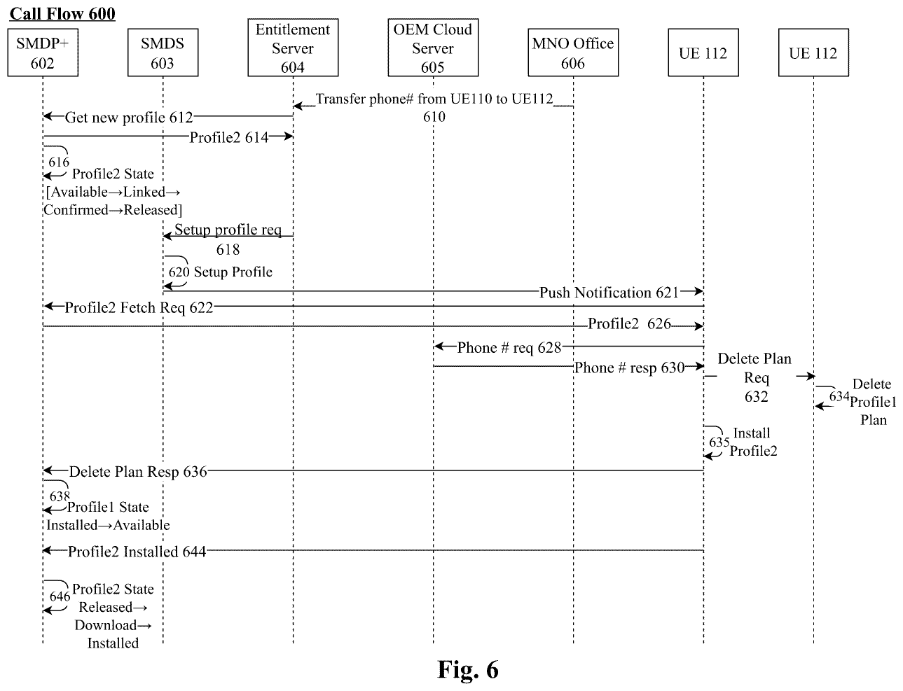

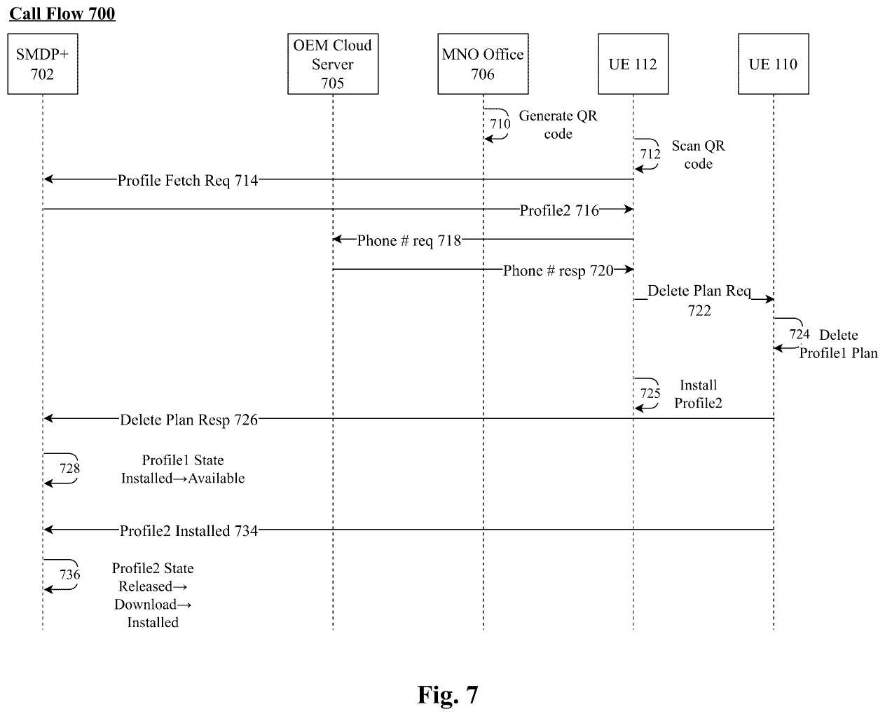

The fourth aspect may be understood by reference to FIG. 6 and FIG. 7, which show different options of the fourth aspect. The fourth aspect may be applicable to scenarios in which a user brings a UE to an MNO office to begin the process of transferring an eSIM and phone number to a new UE.

FIG. 6 shows a fourth call flow 600, according to various example embodiments. The SM-DP+ 602 and entitlement server 604 are substantially similar to those described previously. FIG. 6 shows an MNO office 606, which may be a physical location of the MNO with the capability of provisioning a user equipment with cellular service from the MNO (e.g., a retail outlet, a service center, etc.). FIG. 6 also shows an SMDS 603, which may be a discovery service that provides profile information related to eSIM provisioning. A typical use case for the call flow of FIG. 6 would be a user going to an MNO office to begin an eSIM/phone number transfer to a new UE.

It should be noted that in FIG. 6 and FIG. 7, the eSIM profile is recycled, but is not reused. In other words, at the conclusion of the call flows 600 and 700, the eSIM profile installed on the UE 110 (the old UE) is not the eSIM profile installed on UE 112. Instead, the original eSIM profile will be left in the available state, with a new eSIM profile installed on the UE 112. However, the original eSIM profile is then available for the MNO to reuse at a later time for the same subscriber or for a different subscriber.

In 610, the MNO office 606 transmits a transfer phone number request to the entitlement server 604, e.g., transfer the phone number from the UE 110 to the UE 112. In 612, the entitlement server 604 transmits a get new profile request to the SM-DP+ 602. Again, the profile request is pulling a new eSIM profile (Profile2), not the eSIM profile currently installed on the UE 110 (Profile1).

In 614, the SM-DP+ 602 transmits Profile2 to the entitlement server 604. In 616, the SM-DP+ 602 updates the profile state of Profile2 from available to linked to confirmed to released. Each of these eSIM profile states were described above.

In 618, the entitlement server 604 transmits a setup profile request to the SMDS 603. In 620, the SMDS 603 sets up the eSIM profile (Profile2) for the UE 112. As described above, the SMDS 603 includes information of all cellular plans available on any device on the same account. The SMDS 603 now associates the eSIM profile (Profile2) with the device (e.g., UE 112) for the relevant account. Thus, the SMDS 603 will be up to date regarding cellular plans available devices for the subscriber's account.

In 621, the SMDS 603 transmits a push notification to the UE 112. The push notification 622 informs the UE 112 that it may proceed with a profile fetch. In 622, the UE 112 transmits a profile fetch request (e.g., of Profile2) to the SM-DP+ 602.

In 626, the SM-DP+ transmits the eSIM Profile2 to the UE 112. It should be again noted that at the conclusion of the operation 626, Profile1 is installed on the UE 110 and Profile2 is in the released state (e.g., not installed on the UE 112).

In 628, the UE 112 transmits a phone number request to the OEM cloud server 605. The OEM cloud server 605 is aware of UEs connected with an OEM cloud account. The OEM cloud server is also aware of the type of UE transmitting the request 628. The example embodiments are primarily related to same-type UE eSIM transfers (e.g., smartphone to smartphone) but this behavior could be modified (different-type UE) by way of an additional flag in the request 628. The OEM cloud server 605 knows that the UE 110 and the UE 112 are the same device type. With this knowledge, the OEM cloud server 605 knows that UE 112 is going to take the phone number of the UE 110.

In 630, the OEM cloud server 605 transmits the list of devices using the phone number to the UE 112. The UE 112 may then use the information in this list to select the UE 110 and, in 632, the UE 112 transmits a delete plan request to the UE 110.

In 634, the UE 110 deletes the eSIM Profile1. The UE 110 no longer has access to the phone number of the user. In 635, the UE 112 installs the eSIM Profile2. In some examples (not shown), the UE 112 may receive a notification from the UE 110 that the eSIM Profile1 has been deleted before installing the eSIM Profile 2. However, this is not a requirement for the eSIM2 Profile2 to be installed.

In 636, the UE 110 transmits a delete notification to the SM-DP+ 602. In 638, the SM-DP+ 602 updates the Profile1 state from installed to available. The eSIM Profile1 is now available for a future user.

In 644, the UE 112 transmits an eSIM Profile2 install notification to the SM-DP+ 602. In 646, the SM-DP+ 602 updates the eSIM Profile2 state from released to downloaded to installed.

At the conclusion of the call flow 600, the original eSIM profile (Profile1) has been made available for future use, and a new profile (Profile2) is now installed on the new UE 112. It should be noted that Profile2 itself may have been “recycled” from a third UE, before the call flow 600 begins.

FIG. 7 shows a fifth call flow 700, according to various example embodiments. The call flow 700 represents a second option of the fourth aspect.

The SM-DP+ 702, SMDS 703, Entitlement server 704, OEM cloud server 705, and MNO office 706 are substantially similar to those described in previous figures.

In 710, the MNO Office 706 generates a QR code. The QR code may include one or more of an ICCID, mobile country code (MCC), mobile network code (MNC), group 1 identifier (GID1), group 2 identifier (GID2), international mobile subscriber identity (IMSI), the Transfer Token (received in 407), an indication of Is Plan Active (i.e., whether the user has a cellular plan with the MNO), International Mobile Equipment Identity (IMEI), embedded identity document (EID), Serial Number, Label, Phone Number, UE software version, and Product Class (e.g., iPhone, iPad).

In 712, the UE 112 (e.g., the new UE) scans the QR code. In 714, the UE 112 transmits a profile fetch request to the SM-DP+ 702. In 716, the SM-DP+ 702 transmits Profile2 to the UE 112.

In 717, the SM-DP+ updates the state of Profile2 from available to linked to confirmed to released. In 718, the UE 112 transmits a phone number request to the OEM Cloud server 705.

In 720, the OEM cloud server 706 responds to the UE 112 with the phone number list of UEs associated with the phone number of the user. The UE 112 may then use the information in this list to select the UE 110 and, in 722, the UE 112 transmits a delete plan request to the UE 110.

In 724, the UE 110 deletes the Profile1 plan. The UE 110 no longer has access to the phone number of the user. In 725, the UE 112 installs the eSIM Profile2. In some examples (not shown), the UE 112 may receive a notification from the UE 110 that the eSIM Profile1 has been deleted before installing the eSIM Profile2. However, this is not a requirement for the eSIM Profile2 to be installed.

In 726, the UE 110 transmits a delete plan response to the SM-DP+ 702. In 728, the SM-DP+ 702 updates the state of eSIM Profile1 from installed to available. The eSIM Profile1 may now be used again for a future user with a new phone number.

In 734, the UE 112 transmits an eSIM Profile2 install message to the SM-DP+ 702. In 736 the SM-DP+ updates the state of the eSIM Profile2 from released to downloaded to installed.

In the above examples, it was described that the old UE (e.g., UE 110) sent a message to the SM-DP+ to indicate the eSIM profile has been deleted, e.g., operations 422, 520, 636, 726. However, as described above, when the UE 110 deletes the eSIM profile, the UE 110 will no longer have cellular access. Thus, the UE 110 has to send such a message using a different data network. If the UE 110 does not have access using a different data network, the SM-DP+ may never receive the message to indicate the eSIM profile has been deleted and the eSIM profile will remain in the installed state, meaning that the eSIM profile cannot be reused.

Therefore, in some example embodiments, the original (source UE) may be required to have WiFi access to participate in the transfer process, e.g., so the source UE may send the message to the SM-DP+ indicating the eSIM profile state may be changed to available, thereby allowing the eSIM profile to be reused. For example, when invoking the transfer call flow (e.g., call flow 600, call flow 700, etc.), there may be an extra check on the source device UE 110 to determine if the source device UE 110 has WiFi access. If the source device UE 110 does not have WiFi access the transfer call flow may be stopped or delayed, e.g., the user may be provided an indication to connect the source device UE 110 to WiFi to continue the transfer process.

In other example embodiments, the new UE (e.g., UE 112) may send the message to the SM-DP+ to indicate the eSIM profile has been deleted. As will be described below, this message may be sent directly or indirectly to the SM-DP+. For example, when the UE 110 deletes the eSIM profile, the UE 110 may send a short range communication message (e.g., Bluetooth) to the UE 112. In the transfer call flows where the UE 112 is to reuse the original eSIM profile from the old UE 110 (e.g., call flows 300, 400, 500), the UE 112 may send the message to the entitlement server or the MNO server which may then forward the message to the SM-DP+ allowing the eSIM profile to be placed into the available state and reused by the UE 112.

In the transfer call flows where the original eSIM profile from the old UE 110 is made available for future use (e.g., call flows 600 and 700), when the UE 112 has cellular service via the eSIM profile (e.g., Profile2), the UE 112 may then send the message to the SM-DP+ to indicate the original eSIM profile (Profile1) has been deleted from the UE 110. The SM-DP+ can then update the eSIM state of the original eSIM profile (Profile1) to available for future reuse.

### EXAMPLES

In a first example, a method, comprising storing records for a plurality of embedded subscriber identity module (eSIM) profiles, wherein a record for each eSIM profile comprises a state of the eSIM profile, receiving, from a first user equipment (UE), a message indicating a first eSIM profile has been deleted from the first UE, changing the state of the first eSIM profile from installed to available, receiving a message requesting the first eSIM profile be allocated to a second UE, changing the state of the first eSIM profile to a state allowing the eSIM profile to be downloaded to the second UE and downloading the first eSIM profile to the second UE.

In a second example, the method of the first example, further comprising receiving a message from the second UE indicating the first eSIM profile has been installed on the second UE and changing the state of the first eSIM profile to installed.

In a third example, the method of the first example, wherein the message requesting the first eSIM profile be allocated to a second UE is received from an entitlement server.

In a fourth example, the method of the first example, wherein the message requesting the first eSIM profile be allocated to a second UE is received from a mobile network operator (MNO) server.

In a fifth example, one or more processors configured to perform any of the first through fourth examples.

In a sixth example, a server device configured to perform any of the first through fourth examples.

In a seventh example, a method, comprising sending, to a source user equipment (UE), a delete plan request to delete an embedded subscriber identity module (eSIM) profile, sending, to an entitlement server, a request for the eSIM profile, receiving, from the entitlement server, a response comprising information to retrieve the eSIM profile, fetching the eSIM profile from a subscription manager-data preparation+ (SM-DP+), installing the eSIM profile and sending a confirmation to the SM-DP+ that the eSIM profile was installed.

In an eighth example, the method of the seventh example, further comprising prior to sending the delete plan request, sending a transfer profile request for the eSIM profile to the source UE, receiving, from the source UE, a transfer profile response indicating a transfer of the eSIM profile from the source UE to the target UE can proceed, sending, to the entitlement server, a transfer authorization request and receiving, from the entitlement server, a transfer authorization response indicating the transfer of the eSIM profile from the source UE to the target UE can proceed.

In a ninth example, the method of the seventh example, further comprising receiving, from the source UE, a delete plan response indicating the eSIM profile has been deleted, wherein the request for the eSIM profile is a transfer SIM service request and the response from the entitlement server is a transfer SIM response.

In a tenth example, the method of the seventh example, further comprising scanning a quick response (QR) code displayed by the source UE and determining QR code information from the scanned QR code, wherein the QR code information is related to a transfer of the eSIM from the source UE to the target UE.

In an eleventh example, the method of the tenth example, wherein the QR code information comprises one or more of an Integrated Circuit Card Identification (ICCID), a mobile country code (MCC), a mobile network code (MNC), a group 1 identifier (GID1), a group 2 identifier (GID2), an international mobile subscriber identity (IMSI), the Transfer Token, an indication of Is Plan Active, an International Mobile Equipment Identity (IMEI), an embedded identity document (EID), a Serial Number, Label, a Phone Number, a UE software version, and a Product Class.

In a twelfth example, the method of the tenth example, further comprising sending, to an other equipment manufacturer (OEM) cloud server, a phone number list request, and receiving, from the OEM cloud server, a phone number list response comprising a list of devices are associated with a phone number of the eSIM profile, wherein the target UE sends the delete plan request to the source UE based on at least information included in the list of devices.

In a thirteenth example, the method of the tenth example, wherein the request for the eSIM profile is an install eSIM request and the response from the entitlement server comprises a universal resource locator (URL) of the SM-DP+.

In a fourteenth example, a processor configured to perform any of the seventh through thirteenth examples.

In a fifteenth example, a target user equipment (UE) comprising a transceiver configured to communicate with a network and a processor communicatively coupled to the transceiver and configured to perform any of the seventh through thirteenth examples.

In a sixteenth example, a method, comprising receiving, from a target UE, a delete plan request to delete an embedded subscriber identity module (eSIM) profile, deleting the eSIM profile and sending an indication that the eSIM profile has been deleted from the source UE.

In a seventeenth example, the method of the sixteenth example, wherein the indication that the eSIM profile has been deleted from the source UE is sent to a subscription manager-data preparation+ (SM-DP+).

In an eighteenth example, the method of the sixteenth example, wherein the indication that the eSIM profile has been deleted from the source UE is sent to the target UE.

In a nineteenth example, the method of the sixteenth example, further comprising prior to receiving the delete plan request, receiving a transfer profile request for the eSIM profile from the target UE, sending, to an entitlement server, a transfer authorization request, receiving, from the entitlement server, a transfer authorization response indicating a transfer of the eSIM profile from the source UE to the target UE can proceed and sending, to the target UE, a transfer profile response indicating the transfer of the eSIM profile from the source UE to the target UE can proceed.

In a twentieth example, the method of the sixteenth example, further comprising sending, to the target UE, a delete plan response indicating the eSIM profile has been deleted.

In a twenty first example, the method of the sixteenth example, further comprising generating a quick response (QR) code comprising QR code information to be displayed by the source UE, wherein the QR code information is related to a transfer of the eSIM from the source UE to the target UE.

In a twenty second example, the method of the twenty first example, wherein the QR code information comprises one or more of an Integrated Circuit Card Identification (ICCID), a mobile country code (MCC), a mobile network code (MNC), a group 1 identifier (GID1), a group 2 identifier (GID2), an international mobile subscriber identity (IMSI), the Transfer Token, an indication of Is Plan Active, an International Mobile Equipment Identity (IMEI), an embedded identity document (EID), a Serial Number, Label, a Phone Number, a UE software version, and a Product Class.

In a twenty third example, the method of the sixteenth example, further comprising sending, to an entitlement server, a transfer token request and receiving, from the entitlement server, a transfer token response comprising a transfer token indicating the eSIM profile installed on the source UE can be transferred to another UE.

In a twenty fourth example, a processor configured to perform any of the sixteenth through twenty third examples.

In a twenty fifth example, a source user equipment (UE) comprising a transceiver configured to communicate with a network and a processor communicatively coupled to the transceiver and configured to perform any of the sixteenth through twenty third examples.

In a twenty sixth example, a method, comprising receiving, from a source user equipment (UE), a push notification registration for push notifications related to a transfer of an embedded subscriber identity module (eSIM) profile installed on the source UE, receiving, from a target UE, a request to install the eSIM on the target UE, sending, to the source UE, a push notification indicating the source UE is to delete the eSIM profile, receiving, from the source UE, an indication that the eSIM profile has been deleted, sending, to a subscription manager-data preparation+ (SM-DP+), a request for the eSIM profile to be transferred to the target UE, receiving, from the SM-DP+, a response indicating the eSIM profile is to be transferred to the target UE, the response comprising a universal resource locator (URL) for the SM-DP+ and sending, to the target UE, a response to the request to install the eSIM on the target UE, the response comprising the URL for the SM-DP+.

In a twenty seventh example, one or more processors configured to perform the twenty sixth example.

In a twenty eighth example, a server device configured to perform the twenty sixth example.

In a twenty ninth example, a method comprising scanning a quick response (QR) code displayed by a source user equipment (UE), determining QR code information from the scanned QR code, wherein the QR code information is related to a transfer of an embedded subscriber identity module (eSIM) profile from the source UE to the target UE, sending, to a carrier server, a request for the eSIM profile, receiving, from the carrier server, a response comprising information to retrieve the eSIM profile, wherein the information comprises a universal resource locator (URL) for a subscription manager-data preparation+ (SM-DP+), fetching the eSIM profile from the SM-DP+, installing the eSIM profile and sending a confirmation to the SM-DP+ that the eSIM profile was installed.

In a thirtieth example, a processor configured to perform the twenty ninth example.

In a thirty first example, a target user equipment (UE) comprising a transceiver configured to communicate with a network and a processor communicatively coupled to the transceiver and configured to perform the twenty ninth example.

In a thirty second example, a method, comprising sending, to a carrier server, a push notification registration for push notifications related to a transfer of an embedded subscriber identity module (eSIM) profile installed on the source UE, generating a quick response (QR) code comprising QR code information to be displayed by the source UE, wherein the QR code information is related to the transfer of the eSIM profile from the source UE to a target UE, receiving, from the carrier server, a push notification indicating the source UE is to delete the eSIM profile and sending, to the carrier server, an indication that the eSIM profile has been deleted.

In a thirty third example, a processor configured to perform the thirty second example.

In a thirty fourth example, a source user equipment (UE) comprising a transceiver configured to communicate with a network and a processor communicatively coupled to the transceiver and configured to perform the thirty second example.

In a thirty fifth example, a method, comprising storing records for a plurality of embedded subscriber identity module (eSIM) profiles, wherein a record for each eSIM profile comprises a state of the eSIM profile, receiving, from a first user equipment (UE), a request for a first eSIM profile, sending, to the first UE, the first eSIM profile, receiving, from a second UE, a first indication that a second eSIM profile has been deleted from the second UE, wherein the first UE and the second UE are associated with a same account, updating, in response to the first indication, a state of the second eSIM profile to available, receiving, from the first UE, a second indication that the first eSIM profile has been installed on the first UE and updating, in response to the second indication, a state of the first eSIM profile to installed.

In a thirty sixth example, the method of the thirty fifth example, further comprising receiving, from an entitlement server, a request for a new eSIM profile for the first UE, generating the new eSIM profile for the first UE, wherein the new eSIM profile is the first eSIM profile and sending, to the entitlement server, a response indicating the new eSIM profile is available for the first UE, wherein the response comprises information related to the first eSIM profile.

In a thirty seventh example, one or more processors configured to perform the thirty fifth or thirty sixth examples.

In a thirty eighth example, a server device configured to perform the thirty fifth or thirty sixth examples.

In a thirty ninth example, a method comprising receiving, from an entitlement server, a setup profile request for an embedded subscriber identity module (eSIM) profile for a user equipment (UE), configuring the eSIM profile for the UE and sending a push notification to the UE, wherein the push notification comprises information for the UE to fetch the eSIM profile.

In a fortieth example, one or more processors configured to perform the thirty ninth example.

In a forty first example, a server device configured to perform the thirty ninth example.

In a forty second example, a method, comprising receiving, from a target user equipment (UE), a request for a list of devices associated with a phone number, sending, to the target UE, a response comprising the list of devices associated with the phone number and sending, to a source UE, a request to delete an embedded subscriber identity module (eSIM) profile associated with the phone number.

In a forty third example, one or more processors configured to perform the forty second example.

In a forty fourth example, a server device configured to perform the forty second example.

In a forty fifth example, a method, comprising scanning a quick response (QR) code generated by a mobile network operator, determining QR code information from the scanned QR code, wherein the QR code information is related to a first embedded subscriber identity module (eSIM) profile and comprises a universal resource locator (URL) for a subscription manager-data preparation+ (SM-DP+), fetching the first eSIM profile from the SM-DP+, sending, to an other equipment manufacturer (OEM) cloud server, a phone number list request, receiving, from the OEM cloud server, a phone number list response comprising a list of devices are associated with a phone number of the first eSIM profile, sending, to a source UE that is one of the list of devices associated with the phone number, a delete plan request to delete a second eSIM profile associated with the phone number, installing the first eSIM profile and sending a confirmation to the SM-DP+ that the first eSIM profile was installed.

In a forty sixth example, a processor configured to perform the forty fifth example.

In a forty seventh example, a target user equipment (UE) comprising a transceiver configured to communicate with a network and a processor communicatively coupled to the transceiver and configured to perform the forty fifth example.

In a forty eighth example, a method, comprising receiving, from a target UE comprising a first embedded subscriber identity module (eSIM) profile associated with a phone number, a delete plan request to delete a second eSIM profile associated with the phone number, deleting the second eSIM profile and sending a confirmation to a subscription manager-data preparation+ (SM-DP+) that the second eSIM profile was deleted.

In a forty ninth example, the method of the forty eighth example, wherein the confirmation is sent via a signal management discovery service (SMDS).

In a fiftieth example, a processor configured to perform the forty eighth or forty ninth examples.

In a fifty first example, a source user equipment (UE) comprising a transceiver configured to communicate with a network and a processor communicatively coupled to the transceiver and configured to perform the forty eighth or forty ninth examples.

In a fifty second example, a method, comprising sending, to a source UE, a delete plan request to delete an embedded subscriber identity module (eSIM) profile, receiving, from the source UE, a delete notification indicating the eSIM profile has been deleted from the source UE and sending the delete notification to a subscription manager-data preparation+ (SM-DP+).

In a fifty third example, a processor configured to perform the fifty second example.

In a fifty fourth example, a target user equipment (UE) comprising a transceiver configured to communicate with a network and a processor communicatively coupled to the transceiver and configured to perform the fifty second example.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
storing records for a plurality of embedded subscriber identity module (eSIM) profiles, wherein a record for each eSIM profile comprises a state of the eSIM profile;
receiving, from a first user equipment (UE), a message indicating a first eSIM profile has been deleted from the first UE;
changing the state of the first eSIM profile from installed to available;
receiving a message requesting the first eSIM profile be allocated to a second UE;
changing the state of the first eSIM profile to a state allowing the eSIM profile to be downloaded to the second UE; and
downloading the first eSIM profile to the second UE.

2. The method of claim 1, further comprising:
receiving a message from the second UE indicating the first eSIM profile has been installed on the second UE; and
changing the state of the first eSIM profile to installed.

3. The method of claim 1, wherein the message requesting the first eSIM profile be allocated to a second UE is received from an entitlement server.

4. The method of claim 1, wherein the message requesting the first eSIM profile be allocated to a second UE is received from a mobile network operator (MNO) server.

5. An apparatus comprising a processor and memory coupled to the processor, the processor configured to:
prepare a delete plan request, to be sent to a source user equipment (UE), to request deletion of an embedded subscriber identity module (eSIM) profile on the source UE;
prepare an entitlement server request for the eSIM profile;
receive, in response to transmission of the entitlement server request, a response comprising information to retrieve the eSIM profile;
obtain the eSIM profile from a subscription manager-data preparation+ (SM-DP+);
install the eSIM profile; and
prepare a confirmation to be sent to the SM-DP+ that indicates that the eSIM profile was installed.

6. The apparatus of claim 5, wherein the processor is further configured to:
prior to sending the delete plan request, prepare a transfer profile request for the eSIM profile to be sent to the source UE;
receive, from the source UE, a transfer profile response indicating a transfer of the eSIM profile from the source UE to the target UE can proceed;
prepare a transfer authorization request to be sent to the entitlement server; and
receive, from the entitlement server, a transfer authorization response indicating the transfer of the eSIM profile from the source UE to the target UE can proceed.

7. The apparatus of claim 5, wherein the processor is further configured to:
receive, from the source UE, a delete plan response indicating the eSIM profile has been deleted, wherein the request for the eSIM profile is a transfer SIM service request and the response from the entitlement server is a transfer SIM response.

8. The apparatus of claim 5, wherein the processor is further configured to:
process a scan of a quick response (QR) code displayed by the source UE; and
determine QR code information from the scanned QR code, wherein the QR code information is related to a transfer of the eSIM from the source UE to the target UE.

9. The apparatus of claim 8, wherein the QR code information comprises one or more of an Integrated Circuit Card Identification (ICCID), a mobile country code (MCC), a mobile network code (MNC), a group 1 identifier (GID1), a group 2 identifier (GID2), an international mobile subscriber identity (IMSI), the Transfer Token, an indication of Is Plan Active, an International Mobile Equipment Identity (IMEI), an embedded identity document (EID), a Serial Number, Label, a Phone Number, a UE software version, and a Product Class.

10. The apparatus of claim 8, wherein the processor is further configured to:
prepare a phone number list request to be sent to an other equipment manufacturer (OEM) cloud server;
receive, from the OEM cloud server, a phone number list response comprising a list of devices are associated with a phone number of the eSIM profile, wherein the target UE sends the delete plan request to the source UE based on at least information included in the list of devices.

11. The apparatus of claim 8, wherein the request for the eSIM profile is an install eSIM request and the response from the entitlement server comprises a universal resource locator (URL) of the SM-DP+.

12. An apparatus comprising a processor and memory coupled to the processor, the processor configured to:
receive, from a target user equipment (UE), a delete plan request to delete an embedded subscriber identity module (eSIM) profile from a source UE;
delete the eSIM profile; and
prepare an indication that the eSIM profile has been deleted from the source UE.

13. The apparatus of claim 12, wherein the indication that the eSIM profile has been deleted from the source UE is sent to a subscription manager-data preparation+ (SM-DP+).

14. The apparatus of claim 12, wherein the indication that the eSIM profile has been deleted from the source UE is sent to the target UE.

15. The apparatus of claim 12, wherein the processor is further configured to:
prior to receiving the delete plan request, receive a transfer profile request for the eSIM profile from the target UE;
prepare, for sending to an entitlement server, a transfer authorization request;
receive, from the entitlement server, a transfer authorization response indicating a transfer of the eSIM profile from the source UE to the target UE can proceed; and
prepare, for sending to the target UE, a transfer profile response indicating the transfer of the eSIM profile from the source UE to the target UE can proceed.

16. The apparatus of claim 12, wherein the processor is further configured to:
prepare, for sending to the target UE, a delete plan response indicating the eSIM profile has been deleted.

17. The apparatus of claim 12, wherein the processor is further configured to:
generate a quick response (QR) code comprising QR code information to be displayed by the source UE, wherein the QR code information is related to a transfer of the eSIM from the source UE to the target UE.

18. The apparatus of claim 17, wherein the QR code information comprises one or more of an Integrated Circuit Card Identification (ICCID), a mobile country code (MCC), a mobile network code (MNC), a group 1 identifier (GID1), a group 2 identifier (GID2), an international mobile subscriber identity (IMSI), the Transfer Token, an indication of Is Plan Active, an International Mobile Equipment Identity (IMEI), an embedded identity document (EID), a Serial Number, Label, a Phone Number, a UE software version, and a Product Class.

19. The apparatus of claim 12, wherein the processor is further configured to:
prepare, for sending to an entitlement server, a transfer token request; and
receive, from the entitlement server, a transfer token response comprising a transfer token indicating the eSIM profile installed on the source UE can be transferred to another UE.
